(19) United States
(12) Patent Application Publication
(10) Pub. No.: US 2015/0147623 A1
(43) Pub. Date: May 28, 2015

(54) METHOD FOR CONNECTING TWO BATTERY TERMINALS, MADE OF DISSIMILAR MATERIALS, OF TWO BATTERY CELLS AND BATTERY UNIT

(71) Applicant: Robert Bosch GmbH, Stuttgart (DE)

(72) Inventor: Reiner Ramsayer, Rutesheim (DE)

(21) Appl. No.: 14/402,049

(22) PCT Filed: Apr. 23, 2013
(86) PCT No.: PCT/EP2013/058345

§ 371 Date: Nov. 18, 2014

(30) Foreign Application Priority Data
May 18, 2012 (DE) 10 2012 208 352.9

(51) Int. Cl. H01M 2/20; B23K 13/01

(52) U.S. Cl. CPC H01M 2/204; H01M 2/206; B23K 13/01
USPC 429/121; 219/617

(57) ABSTRACT

A method is described for connecting two battery terminals, made of dissimilar materials, of two battery cells with the aid of a form-fitting, and/or force-locking and/or integrally bonded connection. The two battery terminals are interconnected in a connecting region with the aid of an electromagnetic pulse method, in particular by a magnetic pulse welded connection.

### FIELD OF THE INVENTION

The present invention relates to a method for connecting two battery terminals made of dissimilar materials of two battery cells. Furthermore, the present invention relates to a battery unit including interconnected battery cells.

### BACKGROUND INFORMATION

Such a method and such a battery unit are known from German Published Patent Application No. 10 2009 046 505. With the known method and its battery unit, it is provided that the terminal of a first battery cell is interconnected directly to the terminal of a second battery cell with the aid of a force-locking, form-fitting or integrally bonded connection. The two terminals of the two battery cells are made of dissimilar materials, these materials being copper and aluminum in particular. The provided connecting method includes welding methods and clinching methods or, alternatively, a screw connection of the two battery terminals.

Lithium-ion batteries, such as those provided today as an energy source for driving a drive motor for use in a hybrid vehicle in particular, have battery terminals made of different materials for design-related reasons. Connecting heteropolar battery terminals therefore results in the problem that a battery terminal made of copper in particular must be connected to a battery terminal made of aluminum. Since a battery unit usually includes a plurality of individual battery cells, there is a demand for a preferably low-cost and reliable connecting method, which offers a low contact resistance between the terminals of the battery cells. However, with the method known from the publication cited above, there is the problem that, with regard to the process technology, it is relatively difficult to weld battery terminals made of different materials due to an intermetallic phase in the welding region of the two terminals. In addition, the transition point between the aluminum and the copper is exposed to strong corrosive attacks due to the great difference in the electrochemical potential. When the connection point is located in the immediate vicinity of the so-called terminal in the housing region of a battery cell in particular, there is the risk that the terminal might have a tendency to corrosion because of the ambient conditions due to atmospheric humidity or the like. In principle, such transition points between the terminal and the housing region are therefore protected by additional protective measures such as seals or the like. In summary, this means that a welded connection between two battery terminals made of different materials is difficult to manufacture and requires a relatively great additional effort to protect the connection point from external influences, in particular from corrosion influences.

### SUMMARY

Against the background of the related art presented here, the object of the present invention is to refine a method for connecting two battery terminals made of dissimilar materials of two battery cells, in such a way that, from the standpoint of the process technology, a secure connection is facilitated by using preferably fewer additional components between the battery terminals. This object is achieved according to the present invention by a method by interconnecting the two battery terminals at least indirectly with the aid of an electromagnetic pulse method, in particular with the aid of a magnetic pulse welded connection. Such a method facilitates a reliable connection between the battery terminals made of different materials having a relatively low contact resistance. In addition, the connecting operation is relatively simple to monitor and to control, so that the method may be used to economic advantage in industrial-scale applications, in which a plurality of connections must be established among the battery terminals within a relatively short period of time.

The method according to the present invention makes it possible to establish the connection between the two battery terminals either as a pure crimp connection, as a pure welded connection or as a mixed form between a crimp connection and a welded connection. This permits an optimal adaptation of the connecting operation to the respective application. Thus, for example, it is conceivable to establish the connection as a pure crimp connection by appropriate shaping of the battery terminals. However, if a form-fitting connection or crimp connection cannot be ensured through a corresponding shaping of the battery terminals, the connection may also be established as a pure (cold) welded connection. Given a suitable choice of parameters of the manufacturing device, it is of course also conceivable to establish both a crimp connection and a welded connection simultaneously in the connecting region.

In the case of a battery unit in which the battery terminals of at least two battery cells are interconnected by a method according to the present invention, it is provided that the first battery terminal in the connecting region has a receptacle for an end region of the second battery terminal or that a separate component having a receptacle is provided and is connected to the first battery terminal, and the receptacle of the first battery terminal or of the component surrounds the second battery terminal in as least some regions, preferably radially.

It is particularly preferred if the first battery terminal or the component is made of a softer material than the material of the second battery terminal, at least in the connecting region. Therefore, a corresponding deformation of the outer battery terminal or the component made of a softer material is made possible with a relatively low energy input of the manufacturing device.

It is most particularly preferred if the second battery terminal has a form-fitting geometry in the region cooperating with the receptacle, in particular in the form of a knurling or ribbing. A particularly tight and reliable connection between the battery terminals or between the battery terminal and the component is facilitated by such a form-fitting geometry. In addition, the knurling causes the contact surface between the two battery terminals to increase. Therefore, this enables a reduction in the electrical contact resistance in the connecting region of the two battery terminals.

To minimize or prevent possible corrosion phenomena due to the different materials, it is also preferably provided that at least one of the two battery terminals is provided with a coating, which preferably inhibits corrosion, in particular containing plastic, metal or ceramic, at least in the connecting region. Alternatively or additionally, a metallic coating may also be provided on at least one of the battery terminals in the connecting region to optimize the electrical properties and the contact resistance.

In one structural embodiment for establishing the connection, it is provided that the first battery terminal or the component is designed as or has a cap, preferably made of aluminum, in the connecting region. Such a design of a battery terminal or the component as a cap has the advantage that the receptacle for the second battery terminal is formed in its interior. It may be provided that the first battery terminal and the cap are designed as a one-piece component, so that no additional connections or connecting elements are needed between the first battery terminal and the cap.

Additional advantages, features and details of the present invention are derived from the following description of the preferred exemplary embodiments as well as on the basis of the drawings.

### BRIEF DESCRIPTION OF THE DRAWINGS

FIG. 1 shows a simplified diagram of a battery unit including multiple battery cells.

FIG. 2 shows the connecting region of two battery terminals of two battery cells in a longitudinal section before establishing the connection.

FIG. 3 shows the connecting region according to FIG. 2, also shown in a longitudinal section, after establishing the connection with the aid of an electromagnetic pulse method.

FIG. 4 and FIG. 5 each show modified specific embodiments of the present invention using separate components to form the receptacle for a battery terminal, shown in longitudinal sections.

### DETAILED DESCRIPTION

The same elements or elements having the same function are labeled with the same reference numerals in the figures.

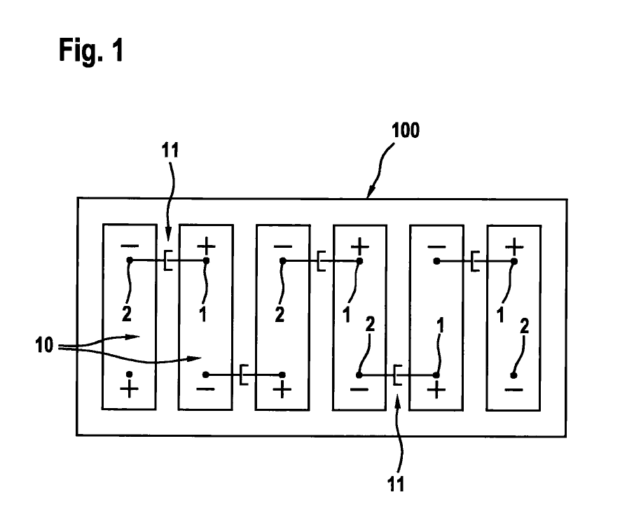

FIG. 1 shows a battery unit 100, including a plurality of interconnected battery cells 10, in a greatly simplified form. For the sake of simplicity, FIG. 1 shows only six interconnected battery cells 10, but such a battery unit 100 may also have more than six battery cells 10 in practice. Such a battery unit 100 is used preferably but not restrictively in a motor vehicle, in particular as an integral part of a hybrid drive. Furthermore, battery cells 10 are lithium-ion battery cells 10 in particular, each having a positive terminal 1 and a negative terminal 2. In the exemplary embodiment illustrated here, all six battery cells 10 are connected electrically in series, so that their individual battery voltages are added up. It is also of course within the scope of the present invention for battery cells 10 to be connected electrically in parallel, at least partially.

It is characteristic of battery cells 10 designed as lithium-ion battery cells 10 for the material of positive terminal 1 and the material of negative terminal 2, which are intended for electrical connection and contacting, to be made of different materials. In particular, one terminal of battery cell 10 is made of aluminum, while the other terminal of battery cell 10 is made of copper. Positive terminal 1 of a first battery cell 10 is connected to a negative terminal 2 of second battery cell 10 according to the present invention by using an electromagnetic pulse method, in particular by a magnetic pulse welded connection in a connecting region 11.

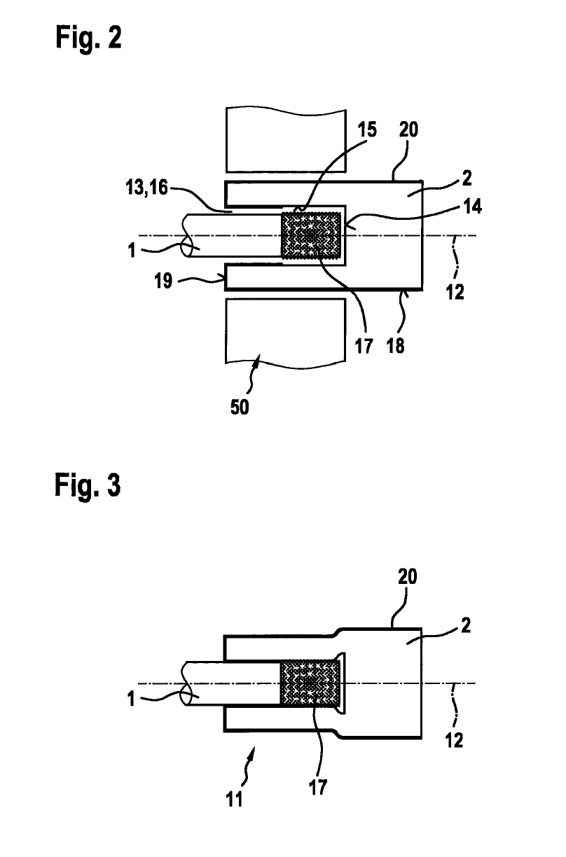

In a first exemplary embodiment of the present invention, FIG. 2 shows connecting region 11 between a positive terminal 1 and a first battery cell 10 and negative terminal 2 of a second battery cell 10 in greater detail. It is assumed here merely as an example and thus without restriction that positive terminal 1 is made of copper, while negative terminal 2 is made of aluminum. In the exemplary embodiment illustrated here, positive terminal 1 and negative terminal 2 are designed to be rotationally symmetrical with a longitudinal axis 12 in connecting region 11. Positive terminal 1 is designed in the form of a pin while negative terminal 2 is designed as a cap on the side facing positive terminal 1, having a receptacle 13 into which the end of positive terminal 1 is insertable. In the region of receptacle 13 in particular, negative terminal 2 is thus designed as a sleeve having a receptacle in an end-side bottom region 14. Wall 15 of negative terminal 2 running radially in the region of receptacle 13 preferably surrounds positive terminal 1 with a peripheral gap 16 designed to be at least approximately uniform.

In modification of the exemplary embodiment depicted here, it is also within the scope of the present invention to modify the shapes of positive terminal 1 and negative terminal 2 in connecting region 11, so that the modified shapes may facilitate the connecting and aligning of positive terminal 1 relative to negative terminal 2, for example. Positive terminal 1 and negative terminal 2 may also have a rectangular or oval shape, for example.

In the exemplary embodiment illustrated here, positive terminal 1 has a form-fitting geometry in the form of knurling 17 within receptacle 13 on the side facing bottom region 14, this knurling extending over approximately half of the length of receptacle 13. In addition, negative terminal 2 made of aluminum is provided with a coating 20 for corrosion prevention at least in the region of its exterior side 18, its front end 19 facing positive terminal 1, and in the region of receptacle 13 up to the axial height of knurling 17. Coating 20 may be plastic, metal or ceramic, for example. Coating 20 may be designed to be continued to the region of the cell housing of battery cell 10. In addition, at least one of the two terminals may be provided with an additional metallic coating at least in connecting region 11 to optimize the contact properties and the electrical contact resistance. Connecting region 11 is operatively connected to an annular (manufacturing) device 50, which is represented only symbolically, to form an electromagnetic pulse method.

FIG. 3 illustrates the condition after device 50 has been activated and the connection between positive terminal 1 and negative terminal 2 has been established. Negative terminal 2 here is deformed radially and constricted in the region of receptacle 13, in such a way that it is connected to positive terminal 1, with the aid of a crimp connection (in the region of knurling 17) and/or a cold welded connection and/or with the aid of a mixed form between a cold welded connection and a crimp connection. The design of the respective connection is determined in particular by the choice of the corresponding parameters of device 50 as well as the geometry of positive terminal 1 and of negative terminal 2.

Receptacle 13 may either be formed on negative terminal 2 in that receptacle 13 is an integral part of negative terminal 2 or of the corresponding region of the cell housing of battery cell 10, as illustrated on the basis of FIGS. 2 and 3.

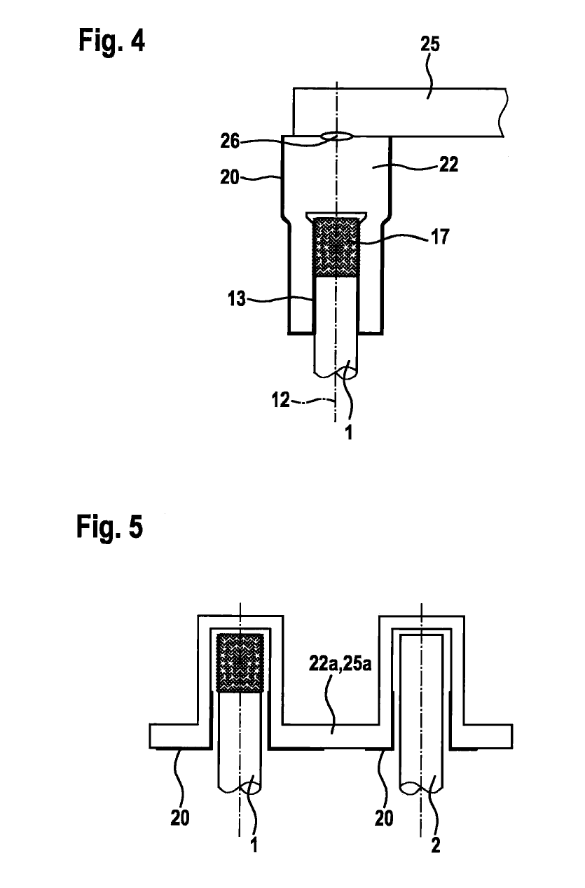

In contrast, FIG. 4 illustrates the case in which receptacle 13 is formed on a separate component 22. Component 22 is preferably made of aluminum and is manufacturable economically advantageously as an extruded part in particular. Component 22 is in turn connected to a cell connector 25. It is essential here that the material of component 22 corresponds to the material of cell connector 25 and that the two components are made of the same type of materials, so that a welded connection 26 may be established easily between component 22 and cell connector 25 by laser welding or ultrasonic welding, for example. Cell connector 25 is in turn connected to negative terminal 2 on the side facing away from component 22, preferably also by a corresponding welded connection (not shown). To this end, the material of negative terminal 2 corresponds to the material of cell connector 25.

In terms of the manufacturing technology, the configuration illustrated in FIG. 4 may be designed particularly advantageously if the connection between the one terminal and component 22, for example, positive terminal 1 and component 22, is created in advance in a first step, so that component 22 and positive terminal 1 form a prefabricated unit. In a second manufacturing step, this unit may then be welded to cell connector 25, which, again in advance, has been welded to negative terminal 2 at the same time or will subsequently be welded to negative terminal 2.

FIG. 5 shows another modification of the present invention. Here, a negative terminal 1 and a positive terminal 2 of two different battery cells 10 to be connected may be seen. The two terminals are interconnected with the aid of a separate component 22a, forming a cell connector 25a at the same time. The material of component 22a is of the same type as the material of negative terminal 2, so that a welded connection may be established easily between component 22a and negative terminal 2 (not shown). In addition, component 22a is designed in the form of a cap in the region of the two terminals. Component 22a has a coating 20 on each terminal in the connecting region of the two terminals.

The connecting technology according to the present invention as described here between positive terminal 1 of a first battery cell 10 and negative terminal 2 of a second battery cell 10 may be modified in a variety of ways without departing from the scope of the present invention.

1.-10. (canceled)

11. A method for connecting two battery terminals, made of dissimilar materials, of two battery cells with the aid of at least one of a form-fitting connection, a force-locking connection, and an integrally bonded connection, comprising:
interconnecting the two battery terminals in a connecting region at least indirectly with the aid of an electromagnetic pulse method.

12. The method as recited in claim 11, wherein the electromagnetic pulse method includes a magnetic pulse welded connection.

13. The method as recited in claim 1, wherein the interconnection is established as one of a pure crimp connection, as a pure welded connection, and as a mixed form between a crimp connection and a welded connection.

14. A battery unit, comprising:
at least two battery cells in which the battery terminals of the battery cells are interconnected in a connecting region by interconnecting the two battery terminals in a connecting region at least indirectly with the aid of an electromagnetic pulse method, wherein one of:
the first battery terminal has in the connecting region a receptacle for an end region of the other, second battery terminal, and
a separate component is provided with the receptacle, which is connected to the first battery terminal, and the receptacle of the first battery terminal or of the component surrounds the second battery terminal in at least some regions

15. The battery unit as recited in claim 14, wherein the receptacle surrounds the second battery terminal radially.

16. The battery unit as recited in claim 15, wherein the first battery terminal or the component s made of a softer material than the material of the second battery terminal, at least in the connecting region.

17. The battery unit as recited in claim 15, wherein the second battery terminal has a form-fitting geometry.

18. The battery unit as recited in claim 17, wherein the form-fitting geometry includes one of a knurling and a ribbing in at least some regions in the region cooperating with the receptacle.

19. The battery unit as recited in claim 13, wherein at least one of the battery terminals is provided with a coating.

20. The battery unit as recited in claim 19, wherein the coating is at least one of corrosion-inhibiting and metallic, at least in the connecting region.

21. The battery unit as recited in claim 20, wherein the coating contains one of a plastic, a metal, and a ceramic.

22. The battery unit as recited in claim 14, wherein the first battery terminal or the component is designed in the form of a cap in the connecting region.

23. The battery unit as recited in claim 22, wherein the cap includes aluminum.

24. The battery unit as recited in claim 14, wherein the component is connected at least indirectly to one of the two battery terminals with the aid of a welded connection.

25. The battery unit as recited in claim 24, wherein the welded connection is achieved one of through a laser welded connection and through an ultrasonic welded connection.

26. The battery unit as recited in claim 24, wherein the component is welded to a cell connector and the cell connector is in turn connected to one of the battery terminals.

27. The battery unit as recited in claim 26, wherein the cell connector is connected to the one of the battery cells through one of a laser welded connection and an ultrasonic welded connection.

28. The battery unit as recited in claim 24, wherein the component is formed by a cell connector.
